(19) United States
(12) Patent Application Publication
(10) Pub. No.: US 2026/0196420 A1
(43) Pub. Date: Jul. 9, 2026

(54) SWITCH DEVICE

(71) Applicant: Alps Alpine Co., Ltd., Tokyo (JP)

(72) Inventor: Naoki HOSHI, Miyagi-ken (JP)

(21) Appl. No.: 19/559,263

(22) Filed: Mar. 6, 2026

Related U.S. Application Data
(63) Continuation of application No. PCT/JP2024/009298, filed on Mar. 11, 2024.

(30) Foreign Application Priority Data
Sep. 29, 2023 (JP) 2023-169816

(51) Int. Cl. H01H 13/22; H01H 13/14

(52) U.S. Cl. CPC H01H 13/22; H01H 13/14

(57) ABSTRACT

A switch device includes a drive member including a detection section or a section to be detected, the drive member being configured to change a relative position between the detection section and the section to be detected by a reciprocating operation in a first direction, a stopper disposed at a position having a fixed relative positional relationship with respect to the other of the detection section and the section to be detected, the stopper being configured to come into contact with the drive member to restrict a range of movement of the drive member, and an elastic member retained to the drive member. The stopper includes a first stopper and a second stopper, and the elastic member includes a first abutment portion, a second abutment portion, and a connecting portion that connects the first abutment portion and the second abutment portion.

### CLAIM OF PRIORITY

This application is a Continuation of International Application No. PCT/JP2024/009298 filed on March 11, 2024, which claims benefit of Japanese Patent Application No. 2023-169816 filed on September 29, 2023. The entire contents of each application noted above are hereby incorporated by reference.

### BACKGROUND OF THE INVENTION

### 1. Field of the Invention

The present invention relates to a switch device, and particularly, relates to a switch device including a stopper for reciprocating motion of a drive member.

### 2. Description of the Related Art

International Publication WO 2010/032814 discloses a switch device that can reduce variations in the synchronization timing of circuit switching even when a plurality of circuits are switched synchronously. The switch device includes a housing having a receiving portion, an operation member that receives a pressing operation, a plurality of fixed contact points provided in the receiving portion side by side at predetermined intervals, a plurality of movable contact points having contact point portions that come into sliding contact with the fixed contact points, and a snap-action mechanism that drives the movable contact points when the operation member is pressed to a predetermined position. The snap-action mechanism in the switch device includes a plurality of first driving bodies having the movable contact points provided at one end side thereof and is formed with a fulcrum portion constituting a rotation fulcrum at the other side thereof, a second driving body which is formed with a pressing target portion to be pressed by the operation member at one end side thereof and is formed with a fulcrum portion constituting a rotation fulcrum at the other end side thereof, and a tensile spring which is attached to a part of a first driving body member in which the plurality of first driving bodies is integrally connected to each other by a connecting member and a part of the second driving body at both ends.

The switch device has a configuration that changes the relative position between a detection section and a section to be detected through a reciprocating motion of a drive member, and includes stoppers disposed at one end and the other end in the reciprocating motion of the drive member to restrict positions in reciprocating motion. Such a switch device including the stoppers may produce impact noise when the drive member comes into contact with the stopper. Accordingly, an elastic member may be provided to the drive member to reduce the impact noise produced between the drive member and the stopper.

However, a force is applied to the elastic member each time the drive member comes into contact with the stopper during a switching operation of the switch device. Therefore, it is necessary to prevent misalignment or detachment of the elastic member. In particular, in such a switch device including the snap-action mechanism, the switching speed of the drive member when an operation member, such as an operation button, is operated does not depend on the operation speed of the operation member. Accordingly, when the elastic member is provided to the drive member, sufficient measures for supporting the elastic member are required compared with known switch devices.

### SUMMARY OF THE INVENTION

The present invention provides a switch device in which an elastic member for suppressing impact noise produced between a drive member and a stopper can be sufficiently supported to the drive member.

According to an embodiment of the present invention, a switch device includes a drive member including a detection section or a section to be detected, the drive member being configured to change a relative position between the detection section and the section to be detected by a reciprocating operation in a first direction, a stopper disposed at a position having a fixed relative positional relationship with respect to the other of the detection section and the section to be detected, the stopper being configured to come into contact with the drive member to restrict a range of movement of the drive member, and an elastic member retained to the drive member. The stopper includes a first stopper configured to restrict movement on one side in the first direction, and a second stopper configured to restrict movement on the other side in the first direction, and the elastic member includes a first abutment portion configured to come into contact with the first stopper, a second abutment portion configured to come into contact with the second stopper, and a connecting portion that connects the first abutment portion and the second abutment portion.

In such a configuration, the elastic member includes a first abutment portion configured to come into contact with the first stopper, a second abutment portion configured to come into contact with the second stopper, and a connecting portion that connects the first abutment portion and the second abutment portion. Accordingly, the first abutment portion and the second abutment portion are integrally retained to the drive member. This configuration prevents detachment or misalignment of the elastic member and reduces impact noise with the stopper, thereby achieving quieter operation.

In the switch device, it is preferable that the elastic member is a separate member comprising a material softer than that of the drive member, and has an engagement structure configured to lock the elastic member to the drive member. In such a case, it is preferable that the elastic member is elastically deformed to be retained to the drive member so as not to fall off. With this configuration, the elastic member is retained to the drive member by its elastic restoring force and is securely fixed by the engagement structure.

In the switch device, the connecting portion may include a first support portion having a portion of the first abutment portion located on the other side in the first direction and supports the first abutment portion, a second support portion having a portion of the second abutment portion located on the one side in the first direction and supports the second abutment portion, and a base portion located between the first support portion and the second support portion. The first support portion and the second support portion may extend in a direction intersecting the first direction, from different positions in the base portion in the first direction. With this configuration, the elastic member can be readily attached to the drive member by holding a portion of the elastic member such as the base portion and moving the elastic member in a direction intersecting the first direction.

The switch device may include a positioning member configured to position the elastic member with respect to the drive member. With this configuration, the elastic member can be securely positioned and fixed to the drive member.

The switch device may comprise a plurality of engagement structures. In such a case, it is preferable that a disengagement direction of at least one of the plurality of engagement structures differs from that of other engagement structures. This prevents all of the engagement structures from disengaging due to an external force applied in a direction different from the first direction, thereby preventing the elastic member from falling off the drive member.

It is preferable that the switch device comprises a fastening auxiliary portion configured to prevent disengagement of the engagement structure. In addition, in the switch device, the fastening auxiliary portion may include a protrusion and a hole into which the protrusion is inserted.

The switch device may include a positioning member configured to position the elastic member with respect to the drive member. The positioning member may include a positioning protrusion provided in the drive member, and an engagement hole provided in the elastic member and into which the positioning protrusion is inserted. The protrusion of the fastening auxiliary portion may be provided to the drive member and protrude in the same direction as the positioning protrusion, and the positioning protrusion may protrude farther than the protrusion of the fastening auxiliary portion. With this configuration, the protrusion engages with the elastic member earlier than the protrusion of the fastening auxiliary portion, and thus engagement of the fastening auxiliary portion is started in the positioned state, and accordingly, improper engagement is less likely to occur. In addition, when engagement of the engagement structure is performed before engagement of the fastening auxiliary portion, occurrence of improper engagement between the protrusion and the engagement hole is more stably suppressed.

In the switch device, it is preferable that the engagement structure includes a concave portion provided in the elastic member, the concave portion opening in the first direction and having a through portion in one of side wall portions thereof, and an engagement protrusion provided in the drive member and configured to pass through the through portion and lock a bottom portion of the concave portion, and in the concave portion, a side wall portion that faces the through portion and is continuous with the bottom portion has a predetermined thickness in a disengagement direction of the engagement structure. With this configuration, in the engagement structure in which an engagement protrusion passes through a through portion and locks a bottom portion of a concave portion, even when the concave portion is provided in the elastic member, reinforcement is achieved by the side wall portion, thereby suppressing elastic deformation at the concave portion.

In the switch device, the drive member may include a first holding portion and a second holding portion disposed side by side in a second direction intersecting the first direction, and a drive coupling section that couples the first holding portion and the second holding portion, and the elastic member may be provided so as to extend across the first holding portion and the second holding portion, and have a first engagement structure that is locked to the first holding portion and a second engagement structure that is locked to the second holding portion. With this configuration, with a first holding portion and a second holding portion as the drive member, one elastic member is retained to the drive member.

In the switch device, when viewed in the first direction, the first abutment portion may have a portion overlapping the drive coupling section. In the switch device, the second abutment portion may comprise two second abutment portions, when viewed in the first direction, one of the two second abutment portions may have a portion overlapping the first holding portion, and the other of the two second abutment portions may have a portion overlapping the second holding portion.

In the switch device, the drive member may have a guide portion that, during assembly of the drive member and the elastic member, comes into contact with the second support portion to elastically deform the base portion and move the second support portion to a position at which the second support portion is engageable with the drive member. This configuration facilitates assembly of the elastic member to the drive member.

In the switch device, it is preferable that the second support portion has, in a portion that comes into contact with the guide portion during assembly of the drive member and the elastic member, an inclined portion having a shape following the guide portion. This configuration prevents the second support portion from being caught during assembly of the elastic member to the drive member.

It is preferable that the switch device includes an engagement structure that locks the second support portion that has moved over the guide portion during assembly of the drive member and the elastic member to the drive member. With this configuration, after the elastic member is assembled to the drive member, detachment of the elastic member is prevented by the engagement structure.

In the switch device, the drive member may have a tapered portion that widens from one side toward the other side in a predetermined opposing direction, the base portion may have, in a first surface having a shape following the tapered portion, on the one side in the opposing direction, a first portion that faces the tapered portion, the second support portion may have, on the other side in the opposing direction, a second portion that faces the tapered portion, and the second portion may have, on the other side in the opposing direction, a second surface that has a shape following the tapered portion. This configuration enables, in assembling the elastic member to the drive member, a second surface of the second support portion to be spread along a tapered portion to be moved over the tapered portion, thereby fixing the elastic member to the drive member with the second portion.

It is preferable that the switch device includes an engagement structure that locks the second portion to the drive member, with an engagement direction being a direction intersecting the opposing direction and the first direction. With this configuration, after the elastic member is assembled to the drive member, detachment of the elastic member is prevented by the engagement structure.

In the switch device, the drive member and the engagement structure may be locked such that opposing surfaces thereof overlap with each other when viewed from the first direction, a side of the drive member opposite to the opposing surface may have a tapered portion, and a side of the engagement structure opposite to the opposing surface may have a surface having a shape following the tapered portion. This configuration enables, in assembling the elastic member to the drive member, the engagement structure to be spread along a tapered portion to be moved over the tapered portion, thereby fixing the elastic member to the drive member with the engagement structure.

In the switch device, it is preferable that at least one of the first abutment portion and the first stopper has an adhesion-preventing portion. In addition, in the switch device, it is preferable that at least one of the second abutment portion and the second stopper has an adhesion-preventing portion. This configuration suppresses damage or operational malfunctions caused by adhesion due to close contact between the surfaces of the elastic member and the drive member.

The switch device may comprise a quick-action mechanism. This configuration effectively prevents detachment or misalignment of the elastic member and reduces impact noise produced between the drive member and the stopper, achieving quieter operation, even when the drive member reciprocates via the quick-action mechanism and its movement range is restricted by the stopper.

### BRIEF DESCRIPTION OF THE DRAWINGS

FIG. 1 is an external perspective view illustrating a switch device according to an embodiment;

FIG. 2 is an exploded perspective view illustrating the switch device according the embodiment;

FIG. 3 is a perspective view illustrating a switch mechanism;

FIG. 4 is a cross-sectional view illustrating a movement of the switch mechanism;

FIG. 5 is a cross-sectional view illustrating a movement of the switch mechanism;

FIG. 6 is a perspective view describing an elastic member;

FIG. 7 is an exploded perspective view describing the elastic member;

FIG. 8 is a perspective view illustrating the elastic member;

FIG. 9 is a perspective view illustrating a state in which the elastic member is to be attached to a hoop material;

FIG. 10 is an exploded perspective view illustrating a state in which the elastic member is to be attached to the hoop material;

FIG. 11 is a perspective view illustrating a method of attaching the elastic member;

FIG. 12 is a cross-sectional view illustrating a method of attaching the elastic member;

FIG. 13 is a perspective view illustrating a method of attaching the elastic member;

FIG. 14 is a cross-sectional view illustrating a method of attaching the elastic member;

FIG. 15 is a perspective view illustrating a method of attaching the elastic member;

FIG. 16 is a cross-sectional view illustrating a method of attaching the elastic member;

FIG. 17A is a partially enlarged view illustrating an engagement state between the elastic member and a drive coupling section;

FIG. 17B is a partially enlarged view illustrating an engagement state between the elastic member and the drive coupling section;

FIG. 17C is a partially enlarged view illustrating an engagement state between the elastic member and the drive coupling section;

FIG. 17D is a partially enlarged view illustrating an engagement state between the elastic member and the drive coupling section;

FIG. 18 is a perspective view illustrating an engagement structure provided for a second support section;

FIG. 19 is a perspective view illustrating another engagement structure; and

FIG. 20 is an enlarged cross-sectional view illustrating another engagement structure.

### DESCRIPTION OF THE PREFERRED EMBODIMENTS

Hereinafter, embodiments of the present invention will be described in detail with reference to the attached drawings. In the following descriptions, the same reference numerals are given to the same components and descriptions of the components described once will be omitted as appropriate.

### SWITCH DEVICE

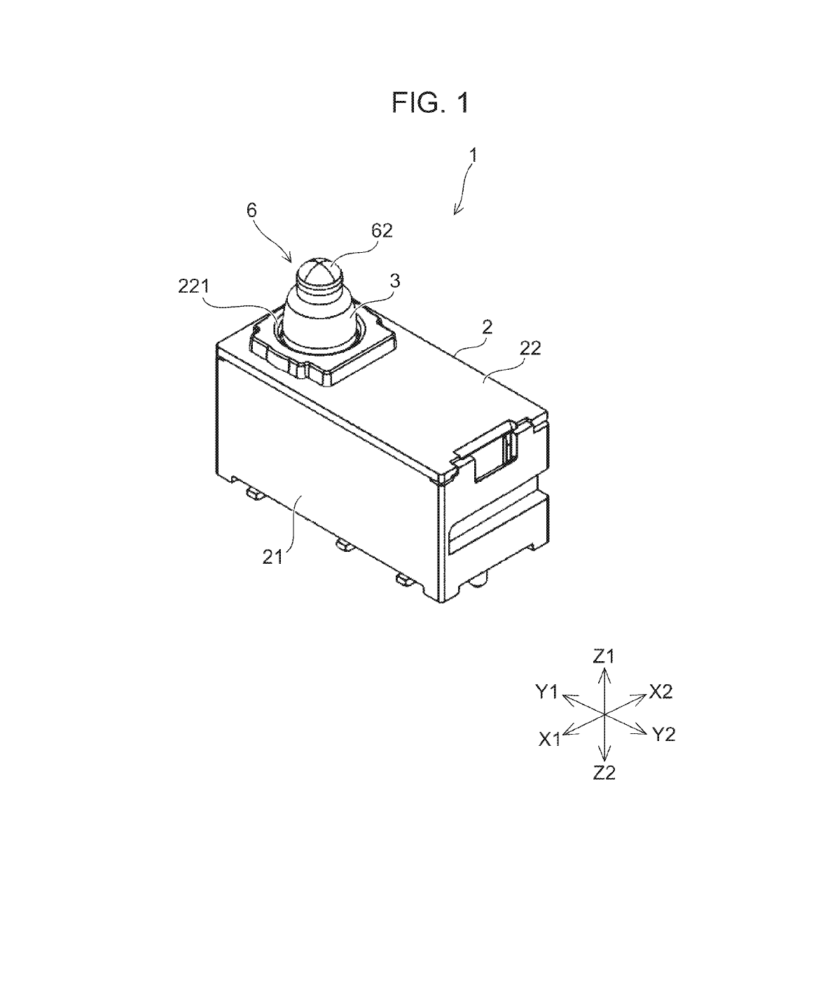

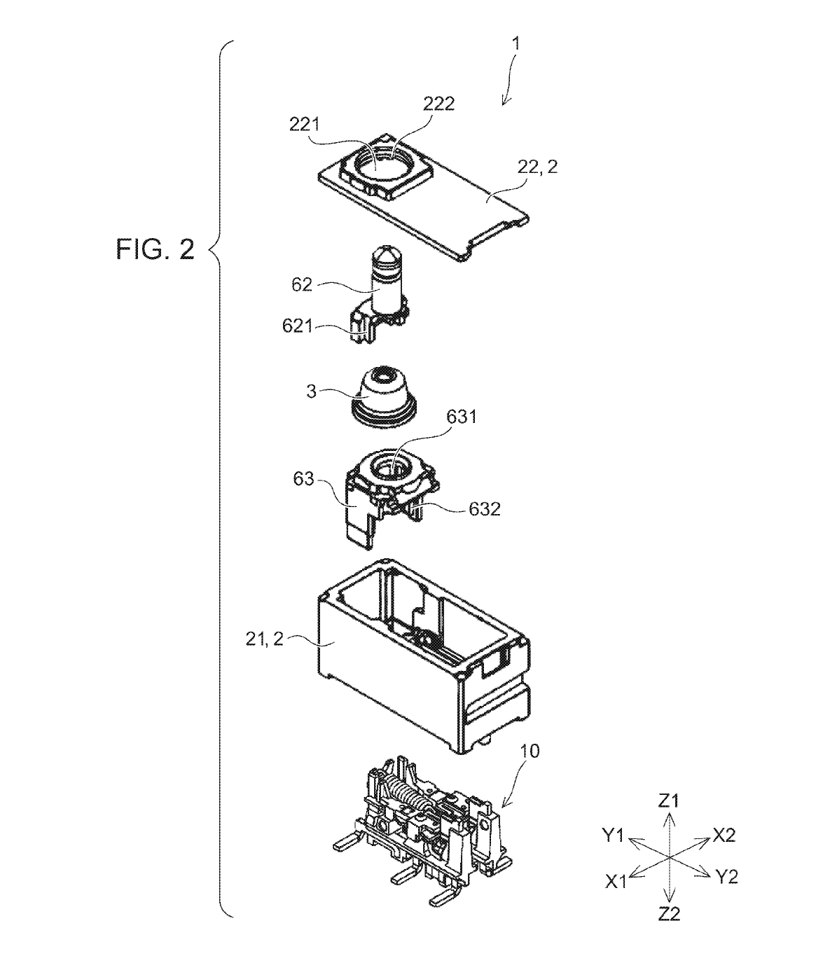

FIG. 1 is an external perspective view illustrating a switch device according to an embodiment. FIG. 2 is an exploded perspective view illustrating the switch device according the embodiment. A switch device 1 according to the embodiment is configured such that a portion of an operation member 6 protrudes from a part of an upper surface of a box-shaped housing 2 and is configured to receive a pressing operation performed by an operator or other person via the operation member 6 to switch a conduction state. Here, in the following description of the embodiment, a direction in which the operation member 6 moves during operation is referred to as a Z1–Z2 direction, one of directions orthogonal to the Z1–Z2 direction is referred to as an X1–X2 direction, and a direction orthogonal to both the Z1–Z2 direction and the X1–X2 direction is referred to as a Y1–Y2 direction. The Z1–Z2 direction is an example first direction. The X1–X2 direction is an example second direction. The Y1–Y2 direction is an example third direction. For convenience of description, the Z1–Z2 direction may also be referred to as an up–down direction, and the Z1 side may also be referred to as an upper side (up) and the Z2 side may also be referred to as a lower side (down).

The switch device 1 includes the housing 2 that is formed, for example, by molding an insulating resin material. The housing 2 includes a box-shaped lower case 21 having an opening on the upper side of the lower case 21, and an upper case 22 that covers the opening on the upper side of the lower case 21. A switch mechanism 10, which will be described below, is assembled within an accommodation space of the lower case 21 and is covered by the upper case 22. A cover 3 is attached to a portion of the operation member 6 protruding from the upper side of the housing 2 to prevent the intrusion of foreign matter such as dust, water, or the like into the housing 2.

The upper case 22 has an opening 221 through which an upper end portion of a shaft section 62 of the operation member 6 can pass. In addition, the upper case 22 has, around the opening 221, a groove portion 222 into which an outer edge portion of the above-described cover 3 is fitted.

The operation member 6 includes the shaft section 62, which is movable in the up-down direction, and a guide section 63 that guides the movement of the shaft section 62. The upper end side of the shaft section 62 protrudes upward from the opening 221 of the upper case 22 through a through hole 631 provided in the guide section 63. The guide section 63 is fitted into the inside of the accommodation space of the lower case 21. A convex portion 632 provided in the guide section 63 and a concave portion 621 provided in the shaft section 62 engage with each other to restrict the movement of the shaft section 62 in the up-down direction.

The switch mechanism 10, which is accommodated in the accommodation space of the lower case 21, engages with the operation member 6 in the accommodation space. The movement of the shaft section 62 of the operation member 6 is transmitted to the switch mechanism 10, and the conduction state is switched by the switch mechanism 10.

### SWITCH MECHANISM

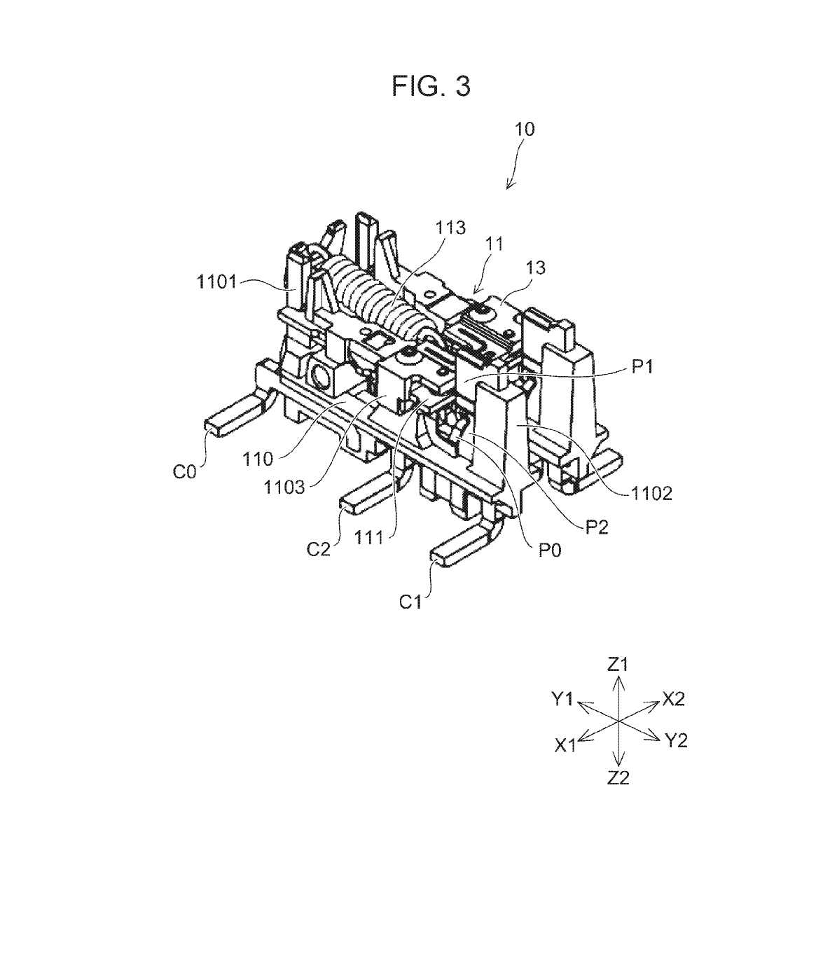

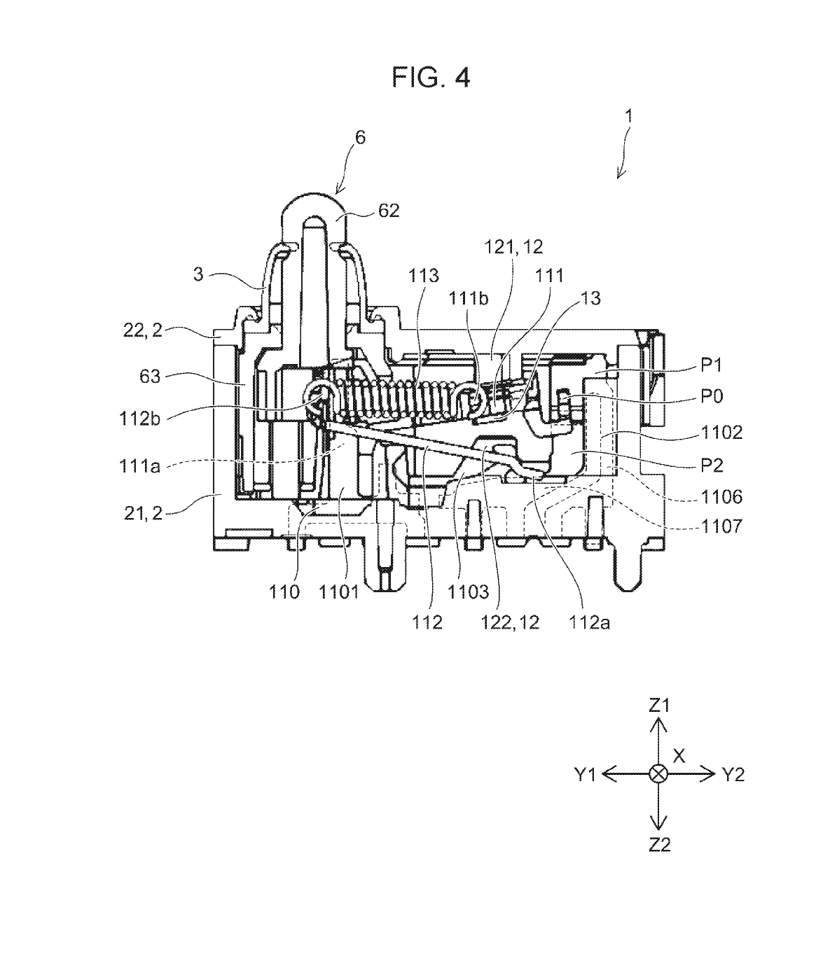

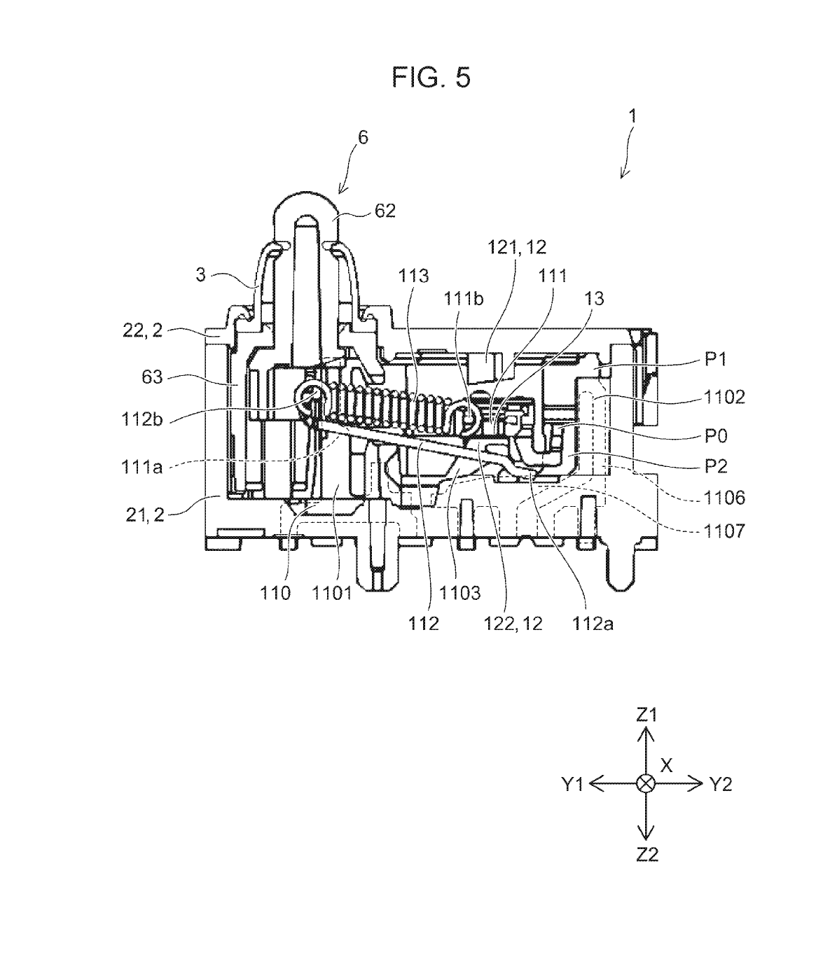

FIG. 3 is a perspective view illustrating the switch mechanism. FIG. 4 and FIG. 5 are cross-sectional views illustrating movements of the switch mechanism. FIG. 4 is a diagram illustrating a first switch state, and FIG. 5 is a diagram illustrating a second switch state. The switch mechanism 10 is a mechanism that switches contacts in response to receiving a pressing force from the shaft section 62 of the operation member 6, and includes a drive member 11, a stopper 12, and an elastic member 13. The drive member 11 has a holding portion 111 and a driving body 112. The holding portion 111 holds a movable contact P0 that switches a connection state with fixed contacts (a first contact P1 and a second contact P2) fixed to a base 110. The driving body 112 swings as the shaft section 62 is moved. A spring 113 is attached between the holding portion 111 and the driving body 112.

Either the fixed contacts (the first contact P1 and the second contact P2) or the movable contact P0 serves as a detection section, and the other contact (contacts) serves as a section to be detected. The holding portion 111 changes a relative position between the detection section and the section to be detected by a reciprocating operation in the Z1-Z2 direction (first direction). One end side 111a of the holding portion 111 is in contact with a first support section 1101 that extends from the base 110, and the holding portion 111 is provided such that the other end side 111b swings in the Z1–Z2 direction about the contacted one end side 111a as a fulcrum. The movable contact P0 is disposed at the other end side 111b of the holding portion 111. The movable contact P0 is disposed, for example, so as to slide with the fixed contacts being interposed in the X1–X2 direction in the movable contact P0. As the holding portion 111 swings, the movable contact P0 reciprocates in the Z1–Z2 direction and slides between and come into contact with the first contact P1 and the second contact P2.

The first contact P1 and the second contact P2, which are fixed contacts, are attached to a second support section 1102 extending from the base 110. The first contact P1 and the second contact P2 are arranged side by side in the Z1–Z2 direction with an insulating region interposed therebetween. As the holding portion 111 swings, the movable contact P0 reciprocates in the Z1–Z2 direction and comes into contact with the first contact P1 or the second contact P2, and thereby electrical connection is switched. Here, the base 110 may be integrally formed with a bottom portion of the lower case 21 by integral molding. Alternatively, the base 110 may be formed as a separate member, and the upper case 22 may have an accommodation space that opens downward, such that the base 110 is joined from a lower side of the upper case 22 so as to cover the opening to form an integrated structure.

The holding portion 111 comprises a metal material, is formed, for example, through sheet-metal processing, and has electrical conductivity. The first support section 1101 with which the holding portion 111 comes into contact also comprises a metal material. The first support section 1101 is electrically connected to a common terminal C0 that passes through the base 110 and extends from the lower side of the base 110. Here, the first support section 1101 and the common terminal C0 may comprise a metal material, and may be integrally provided, for example, through sheet-metal processing.

The second support section 1102, which supports the first contact P1 and the second contact P2, comprises an insulating resin material. The second support section 1102 may be integrally molded with the base 110. The first contact P1 supported by the second support section 1102 is part of a first conductive section 1106 that passes through the base 110. The first conductive section 1106 is electrically connected to a first terminal C1 that extends from the lower side of the base 110. The second contact P2 supported by the second support section 1102 is part of a second conductive section 1107 that passes through the base 110. The second conductive section 1107 is electrically insulated from the first conductive section 1106 and is electrically connected to a second terminal C2 that extends from the lower side of the base 110.

The driving body 112 comprises a metal material, is formed, for example, through sheet-metal processing, and is disposed below the holding portion 111. One end side 112a (opposite side to the fulcrum side of the holding portion 111) of the driving body 112 is in contact with a third support section 1103 that extends from the base 110, and the driving body 112 is disposed such that the other end side 112b swings in the Z1–Z2 direction about the contacted one end side 112a as a fulcrum. Accordingly, the holding portion 111 and the driving body 112 are disposed such that the sides opposite to each other swing in the Z1-Z2 direction respectively. The spring 113 is connected between the other end side 112b of the driving body 112 and the other end side 111b of the holding portion 111.

The other end side 112b of the driving body 112 comes into contact with the shaft section 62 of the operation member 6, and when the shaft section 62 is pressed downward, the other end side 112b of the driving body 112 is pressed downward. When the other end side 112b of the driving body 112 is pressed downward, the force is transmitted to the other end side 111b of the holding portion 111 via the spring 113, thereby causing the holding portion 111 to swing. The holding portion 111, the driving body 112, and the spring 113 serve a snap-action mechanism (quick-action mechanism).

The stopper 12 comes into contact with the drive member 11 to restrict the range of movement of the drive member 11. The stopper 12 includes a first stopper 121 that restricts movement of the drive member 11 on one side (Z1 side) in the Z1-Z2 direction, and a second stopper 122 that restricts movement of the drive member 11 on the other side (Z2 side) in the Z1-Z2 direction. The first stopper 121 is provided, for example, so as to extend downward from a lower surface of the upper case 22. The second stopper 122 is provided, for example, so as to extend upward from the base 110. In this embodiment, an upper end of the third support section 1103 serves as the second stopper 122.

The holding portion 111 of the drive member 11 swings in the Z1–Z2 direction in accordance with movement of the shaft section 62 of the operation member 6, thereby switching a conduction state with a corresponding fixed contact. At this time, when the holding portion 111 is moved toward the Z1 side in the Z1–Z2 direction and comes into contact with the first stopper 121, further movement toward the Z1 side over that position is restricted. On the other hand, when the holding portion 111 is moved toward the Z2 side in the Z1–Z2 direction and comes into contact with the second stopper 122, further movement toward the Z2 side over that position is restricted.

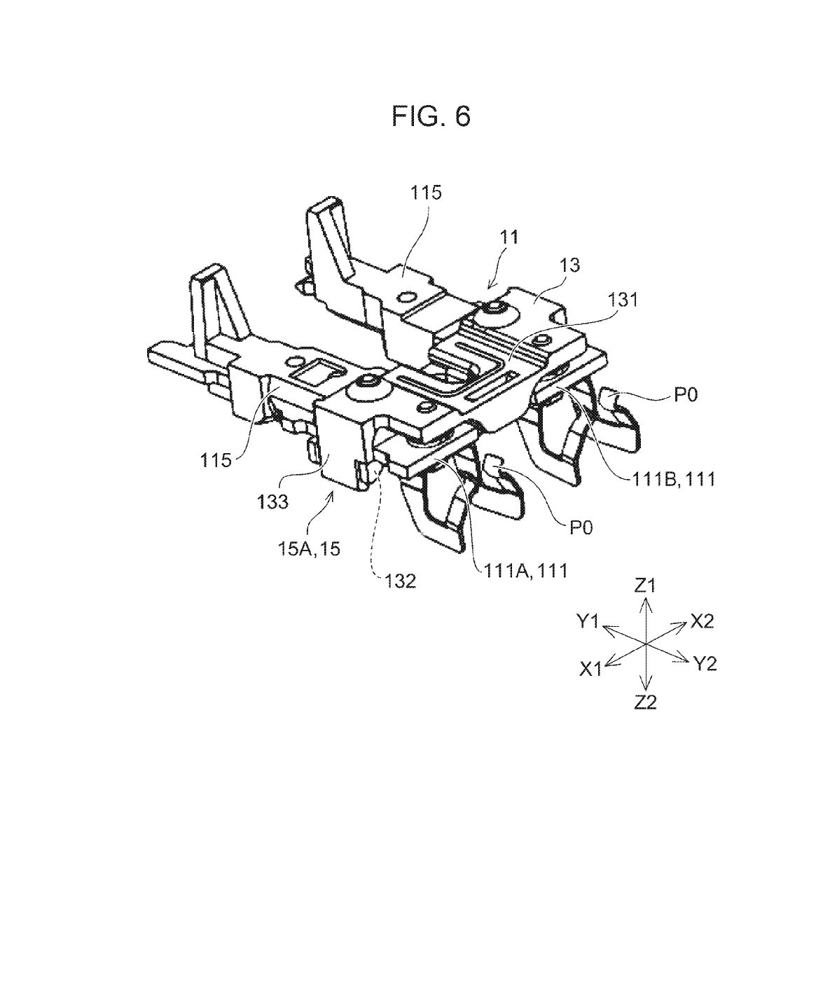

In the switch device 1, the number of the base 110, the first support section 1101, the second support section 1102, the third support section 1103, the first conductive section 1106, the second conductive section 1107, the common terminal C0, the first terminal C1, and the second terminal C2 may each be two. These components are disposed side by side in the X1–X2 direction (second direction). In this case, the drive member 11 includes a first holding portion 111A, a second holding portion 111B, the driving body 112, and a drive coupling section 115 that couples the first holding portion 111A and the second holding portion 111B to each other (see FIG. 6). The first holding portion 111A and the second holding portion 111B are disposed side by side in the X1–X2 direction (second direction).

The drive coupling section 115 comprises an insulating resin material and is attached so as to couple the first holding portion 111A and the second holding portion 111B to each other. In this embodiment, the first holding portion 111A and the second holding portion 111B are integrally held and mechanically coupled by the drive coupling section 115 through insert molding; however, portions embedded in the drive coupling section 115 are separated from each other, such that the first holding portion 111A and the second holding portion 111B are electrically independent of each other. Through coupling by the drive coupling section 115, the first holding portion 111A and the second holding portion 111B operate in conjunction with each other while maintaining electrical insulation therebetween. The driving body 112 is shared by the first holding portion 111A and the second holding portion 111B. In the switch device 1 having these configurations, a plurality of circuits can be synchronously switched, including one circuit including the movable contact P0 held by the first holding portion 111A and corresponding fixed contacts (the first contact P1 and the second contact P2), and another circuit including the movable contact P0 held by the second holding portion 111B and corresponding fixed contacts (the first contact P1 and the second contact P2), thereby ensuring redundancy and increasing fault tolerance.

### SWITCHING OPERATION OF SWITCH DEVICE

Next, a switching operation of the switch device 1 according to the embodiment will be described. As illustrated in FIG. 4, in a state in which no pressing operation is performed (initial state), the movable contact P0 is moved upward and is in contact with the first contact P1. In this state, a circuit is formed in which the first contact P1 (first terminal C1) as a normally closed contact and the movable contact P0 (common terminal C0) are electrically connected to each other (first switch state).

When a pressing operation is received by the operation member 6 and the other end side 112b of the driving body 112 is pressed downward, the other end side 112b swings downward about the one end side 112a of the driving body 112 as a fulcrum, against an urging force of the spring 113. However, until the other end side 112b of the driving body 112 reaches a predetermined limit position, the holding portion 111 remains stopped at the initial position. Accordingly, the state in which the movable contact P0 is in contact with the first contact P1 is maintained.

When the other end side 112b of the driving body 112 swings to the predetermined limit position, the direction of the urging force of the spring 113 acting on the holding portion 111 and the driving body 112 is reversed, and the other end side 111b of the holding portion 111 is pulled downward, and as a result, the other end side 111b of the holding portion 111 instantaneously swings downward about the one end side 111a as a fulcrum (see FIG. 5). In this state, the movable contact P0 slides from the position of the first contact P1 to the position of the second contact P2 and comes into contact with the second contact P2. As a result, a circuit is formed in which the second contact P2 (second terminal C2) as a normally open contact and the movable contact P0 (common terminal C0) are electrically connected to each other (second switch state).

On the other hand, when the pressing operation on the operation member 6 is released, the other end side 112b of the driving body 112 swings upward about the one end side 112a as a fulcrum in accordance with the urging force of the spring 113. However, until the other end side 112b of the driving body 112 reaches a predetermined limit position, the holding portion 111 remains stopped. Accordingly, the state in which the movable contact P0 is in contact with the second contact P2 is maintained.

When the other end side 112b of the driving body 112 swings to the predetermined limit position, the direction of the urging force of the spring 113 acting on the holding portion 111 and the driving body 112 is reversed, and the other end side 111b of the holding portion 111 is pulled upward via the spring 113, and as a result, the other end side 111b of the holding portion 111 instantaneously swings upward about the one end side 111a as a fulcrum and returns to the initial position (see FIG. 4). In this case, the movable contact P0 slides from the position of the second contact P2 to the position of the first contact P1 and comes into contact with the first contact P1. As a result, a circuit is formed in which the first contact P1 (first terminal C1) as a normally close contact and the movable contact P0 (common terminal C0) are electrically connected to each other (first switch state).

As described above, in the snap-action mechanism provided in the switch device 1, when the operation member 6 is pressed to the predetermined limit position, the holding portion 111 provided with the movable contact P0 can be instantaneously driven by the urging force of the spring 113, thereby enabling switching of an electrical conduction state.

### ELASTIC MEMBER

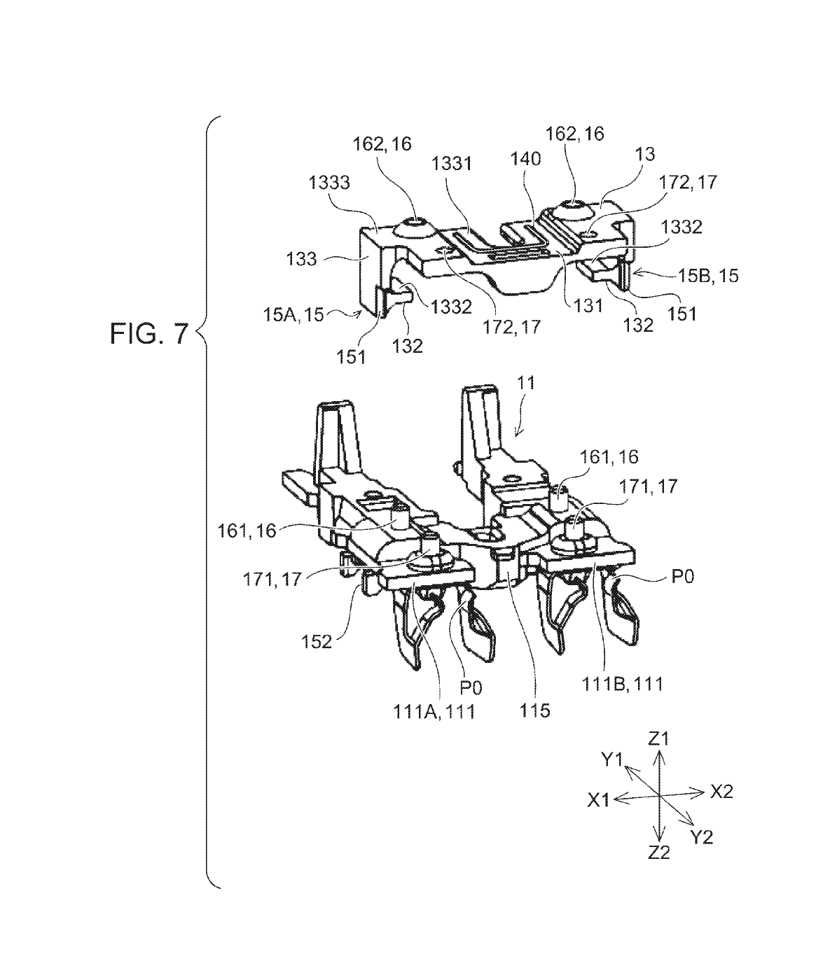

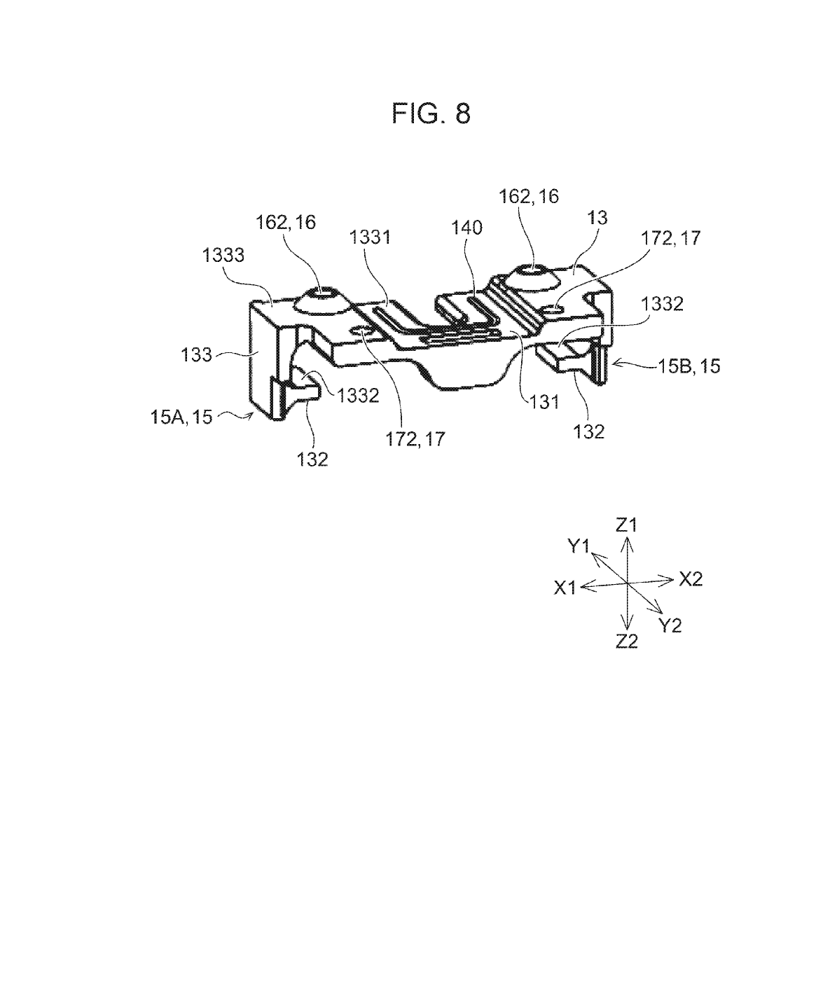

FIG. 6 is a perspective view describing the elastic member. FIG. 7 is an exploded perspective view describing the elastic member. FIG. 8 is a perspective view illustrating the elastic member. The elastic member 13 is held to the drive member 11. In this embodiment, as one specific example, the elastic member 13 is disposed over the drive coupling section 115, which couples the first holding portion 111A and the second holding portion 111B to each other.

The elastic member 13 includes a first abutment portion 131 configured to come into contact with the first stopper 121 (see FIGS. 4 and 5), a second abutment portion 132 configured to come into contact with the second stopper 122 (see FIGS. 4 and 5), and a connecting portion 133 that connects the first abutment portion 131 and the second abutment portion 132. The elastic member 13 comprises a material softer than that of the drive member 11 and is provided separately from the drive member 11. With this configuration, the elastic member 13 is mounted over the drive member 11 by using the elastic force of the elastic member 13. The elastic member 13 is retained to the drive member 11 by the elastic restoring force.

In addition, since the first abutment portion 131 and the second abutment portion 132 are connected to each other by the connecting portion 133, it is not necessary to attach the first abutment portion 131 and the second abutment portion 132 as separate elastic members. Accordingly, by attaching a single (integrated) elastic member 13, attachment of impact-noise reduction members corresponding to the two stoppers (the first stopper 121 and the second stopper 122) is completed.

An engagement structure 15 that locks the elastic member 13 to the drive member 11 is provided between the elastic member 13 and the drive member 11. The engagement structure 15 includes an engaging convex portion 151 provided in the elastic member 13 and an engaging concave portion 152 provided, for example, to the drive coupling section 115 of the drive member 11. The drive member 11 and the engagement structure 15 are locked such that opposing surfaces thereof overlap with each other when viewed from the first direction (Z1–Z2 direction). When the engaging convex portion 151 is engaged with the engaging concave portion 152 in a state in which the elastic member 13 is mounted over the drive coupling section 115, the elastic member 13 is securely fixed to the drive member 11 by the engagement structure 15. In the engagement structure 15, the engagement direction, which is a deformation direction of a member of the engagement structure (the elastic member 13 in this embodiment), is a direction intersecting the first direction (Z1–Z2 direction), for example, the X1–X2 direction, and a locking direction, which is a direction in which relative displacement of the elastic member 13 with respect to the drive member 11 is restricted, is the first direction (Z1–Z2 direction). The direction of locking by the engagement structure 15 coincides with the swinging direction of the holding portion 111, and thus detachment or curling of the elastic member 13 due to swinging of the holding portion 111 is effectively suppressed.

In this specification, the engagement structure means a structure in which the elastic member 13, the drive member 11, and other components produce mutual interaction including mechanical contact. Accordingly, specific examples of the engagement structure include not only the snap-fit structure such as the engagement structure 15 according to the embodiment, but also include fitting and insertion in which a protrusion is inserted into a hole. In the case of fitting or insertion, the engagement direction is a direction that intersects the insertion direction. For example, when a protrusion extending in the first direction is inserted while being elastically deformed, the protrusion presses an inner wall of a fitting hole by an elastic restoring force, and thereby an engagement structure is provided. Accordingly, a radial direction of the fitting hole (direction intersecting the first direction) is the engagement direction. Locking of the protrusion inserted into the fitting hole may be caused by a shear force between an outer surface of the protrusion inserted into the fitting hole and an inner surface of the fitting hole, or alternatively, the protrusion may have a portion having an outer dimension larger than an opening of the fitting hole, and the protrusion may be locked by the portion in contact with the opening. In any case, the locking direction includes the insertion direction (first direction) in which the protrusion is inserted into the fitting hole.

In the above example, the drive coupling section 115 among the components of the drive member 11 locks the elastic member 13; however, it is not limited thereto. The holding portion 111 (the first holding portion 111A and the second holding portion 111B) may lock the elastic member 13 instead. As a specific example, the plate-shaped holding portion 111 having the first direction as a thickness direction may have a through hole or a slit, and the elastic member 13 may partially have, in the first direction, a portion in which the diameter is reduced and may be arranged such that the reduced-diameter portion is positioned within the through hole or the slit. In such a case, a portion of the elastic member 13 that has a larger outer shape and located at an end of the reduced-diameter portion comes into contact with a periphery of an opening of the through hole or the slit of the holding portion 111, and as a result, the elastic member 13 is locked to the drive member 11.

The connecting portion 133 of the elastic member 13 includes a first support portion 1331, a second support portion 1332, and a base portion 1333. The first support portion 1331 integrally supports the first abutment portion 131 that is located on the other side (Z2 side) in the Z1-Z2 direction (first direction) with respect to the first stopper 121 extending downward from the lower surface of the upper case 22 and that faces the first stopper 121. The second support portion 1332 integrally supports the second abutment portion 132 that is located on one side (Z1 side) in the Z1–Z2 direction (first direction) with respect to the second stopper 112 extending upward from the base 110 and that faces the second stopper 112. The base portion 1333 is located between the first support portion 1331 and the second support portion 1332 and has a portion extending in the Z1–Z2 direction.

The first support portion 1331 and the second support portion 1332 are provided at different positions in the base portion 1333 in the Z1–Z2 direction (first direction), that is, at different positions in the up-down direction, and each extends in a direction (for example, the X1–X2 direction) intersecting the first direction. Accordingly, the elastic member 13 can be readily attached to the drive member 11 by holding a portion of the elastic member 13 such as the base portion 1333 and moving the elastic member 13 in a direction (for example, the X1–X2 direction) intersecting the first direction.

In one preferred example, the first support portion 1331 and the second support portion 1332 extend in the same direction from different positions in the base portion 1333 in the up-down direction (Z1–Z2 direction). In this configuration, the elastic member 13 has a U shape with the base portion 1333 serving as a bottom portion. By moving the elastic member 13 so as to accommodate the drive member 11 in the U-shaped opening, the drive member 11 and the elastic member 13 can be readily assembled. For example, when the first support portion 1331 and the second support portion 1332 extend from the base portion 1333 toward the X1 side in the X1–X2 direction, a U-shaped portion defined by the elastic member 13 has an opening that opens toward the X1 side in the X1–X2 direction. Accordingly, by moving the U-shaped portion of the elastic member 13 toward the X1 side in the X1–X2 direction with respect to the drive member 11, the drive member 11 and the elastic member 13 can be readily assembled.

When the drive member 11 includes the first holding portion 111A and the second holding portion 111B, the elastic member 13 is provided so as to extend across the first holding portion 111A and the second holding portion 111B, and has a first engagement structure 15A that is to be locked to the first holding portion 111A and a second engagement structure 15B that is to be locked to the second holding portion 111B. With this configuration, in a state in which the single elastic member 13 is fitted so as to cover the first holding portion 111A and the second holding portion 111B, the elastic member 13 can be securely fixed to the drive member 11 by the first engagement structure 15A and the second engagement structure 15B.

In the elastic member 13 provided so as to extend across the first holding portion 111A and the second holding portion 111B, two second abutment portions 132 are provided. When viewed in the Z1–Z2 direction (first direction), one of the two second abutment portions 132 has a portion overlapping the first holding portion 111A, and the other of the two second abutment portions 132 has a portion overlapping the second holding portion 111B.

At least one of the first abutment portion 131 of the elastic member 13 and the first stopper 121 (see FIG. 4) is provided with an adhesion-preventing portion 140 for preventing sticking when the elastic member 13 and the first stopper 121 come into contact with each other. In the example illustrated in FIG. 8, a convex adhesion-preventing portion 140 is provided on the first abutment portion 131. When the adhesion-preventing portion 140 is provided, a contact area between the first abutment portion 131 and the first stopper 121 is reduced as compared with a case in which the adhesion-preventing portion 140 is not provided. That is, only a part of opposing surfaces of the first abutment portion 131 and the first stopper 121 comes into contact with each other, rather than entire opposing surfaces thereof. Accordingly, sticking that may occur when the first abutment portion 131 and the first stopper 121 remain in an abutting state for a long period of time is suppressed.

The adhesion-preventing portion 140 may be provided on at least one of the second abutment portion 132 and the second stopper 122 (see FIGS. 4 and 5). The adhesion-preventing portion 140 may have any configuration as long as it reduces the contact area between the abutment portion and the stopper, and thus may have a concave shape or a roughened surface instead of the convex shape, or may be formed discontinuously. In addition, the adhesion-preventing portion 140 may have an air flow passage that communicates with inside and outside of opposing surfaces of the abutment portion and the stopper.

### METHOD OF ATTACHING ELASTIC MEMBER

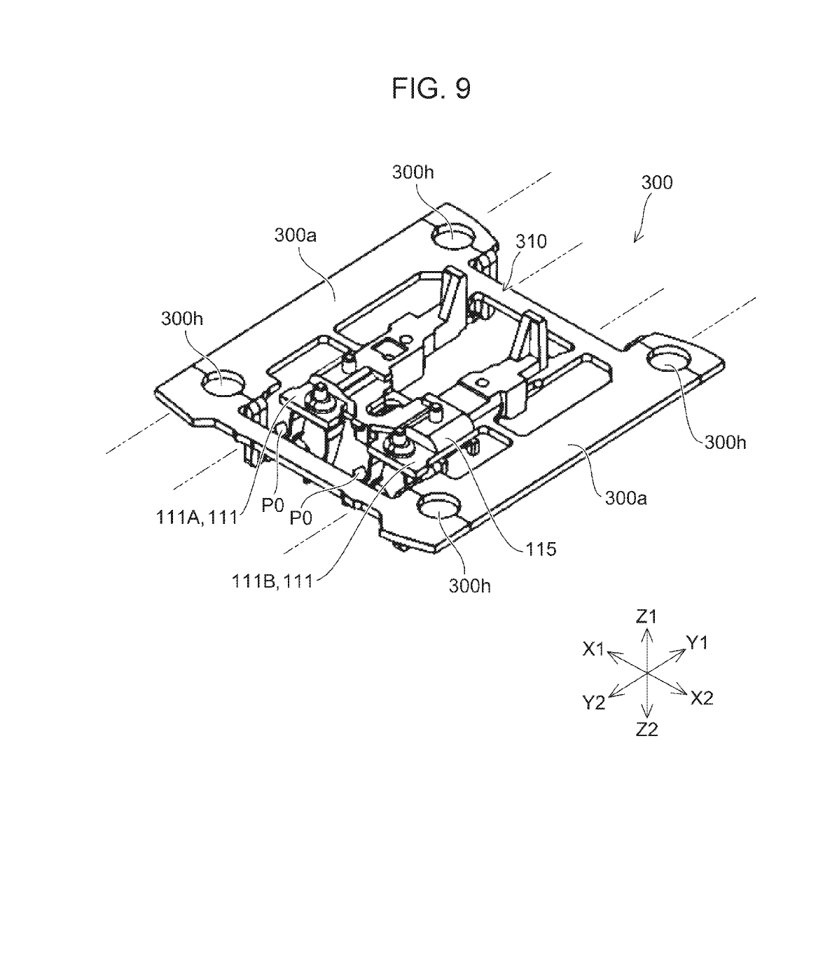

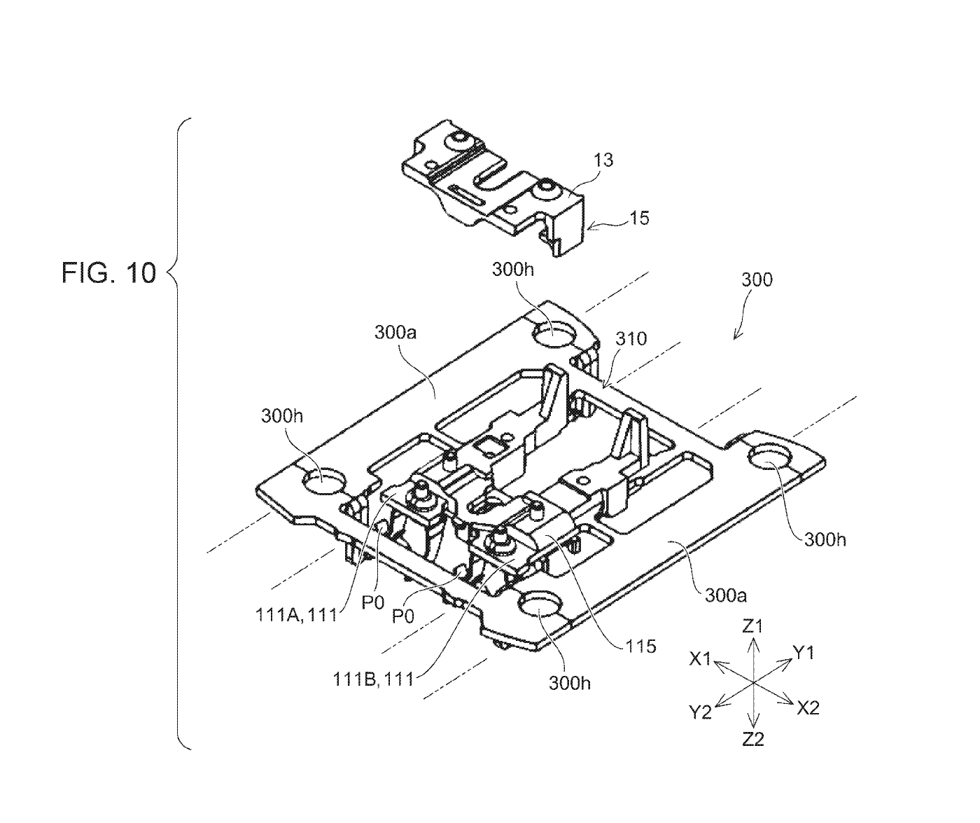

Next, a method of attaching the elastic member 13 will be described. FIG. 9 is a perspective view illustrating a state in which the elastic member is to be attached to a hoop material. FIG. 10 is an exploded perspective view illustrating a state in which the elastic member is to be attached to the hoop material. A hoop material 300, to which the elastic member 13 is to be attached, includes a formed body 310 that has the first holding portion 111A and the second holding portion 111B formed by press-forming a metal plate, and includes the drive coupling section 115. The drive coupling section 115 is integrally fixed to the formed body 310, for example, by insert molding. The movable contacts P0 are attached to distal end portions of the first holding portion 111A and the second holding portion 111B by caulking or the like. The hoop material 300 is formed such that formed bodies 310 and drive coupling sections 115 are continuously formed in one direction (Y1–Y2 direction), and are divided into individual formed bodies 310 after a predetermined assembly process is completed. For convenience of description, FIGS. 9 and 10 illustrate only the portion corresponding to one formed body 310 and one drive coupling section 115 as the hoop material 300.

The hoop material 300 each includes feed holes 300h provided at a predetermined pitch in a frame portion 300a, and by using the feed holes 300h, the hoop materials 300 are sequentially fed by an automatic assembly machine to perform assembly. The elastic member 13 is fitted over the drive coupling section 115 in the state of the hoop material 300.

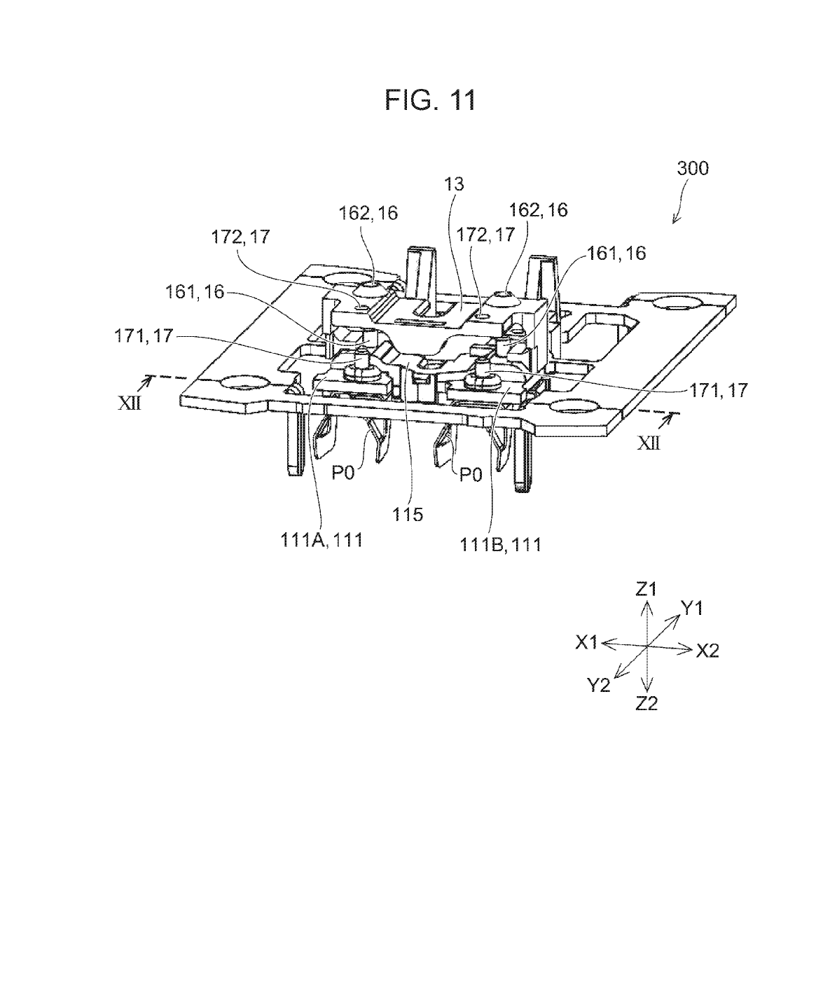

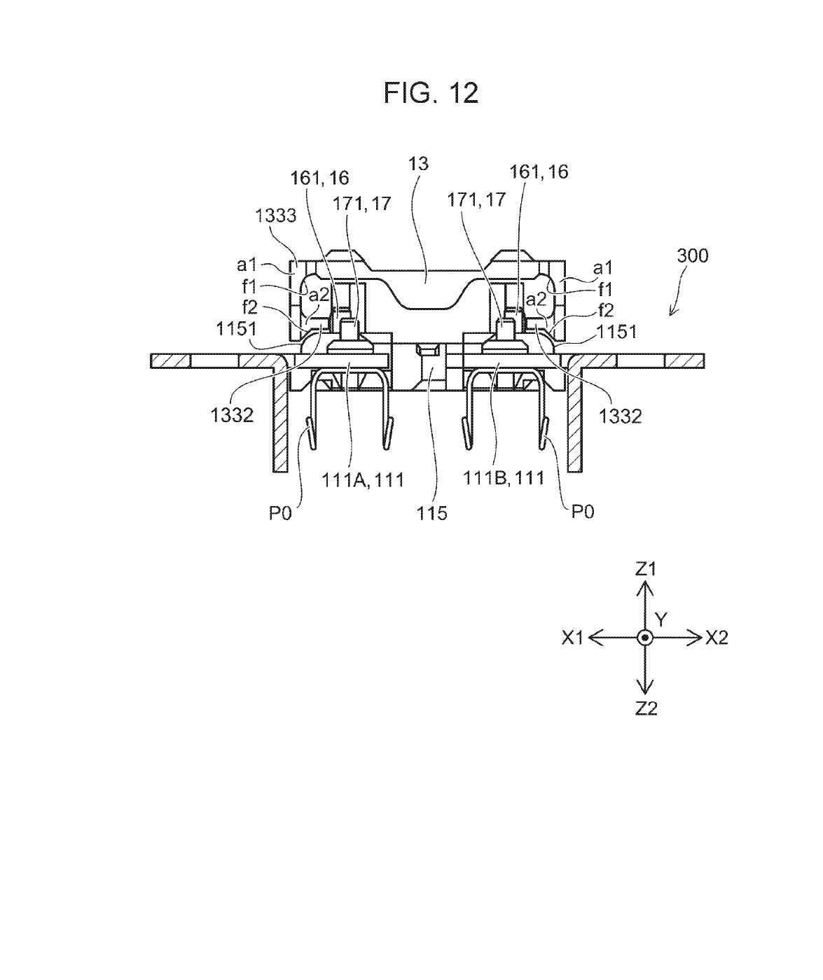

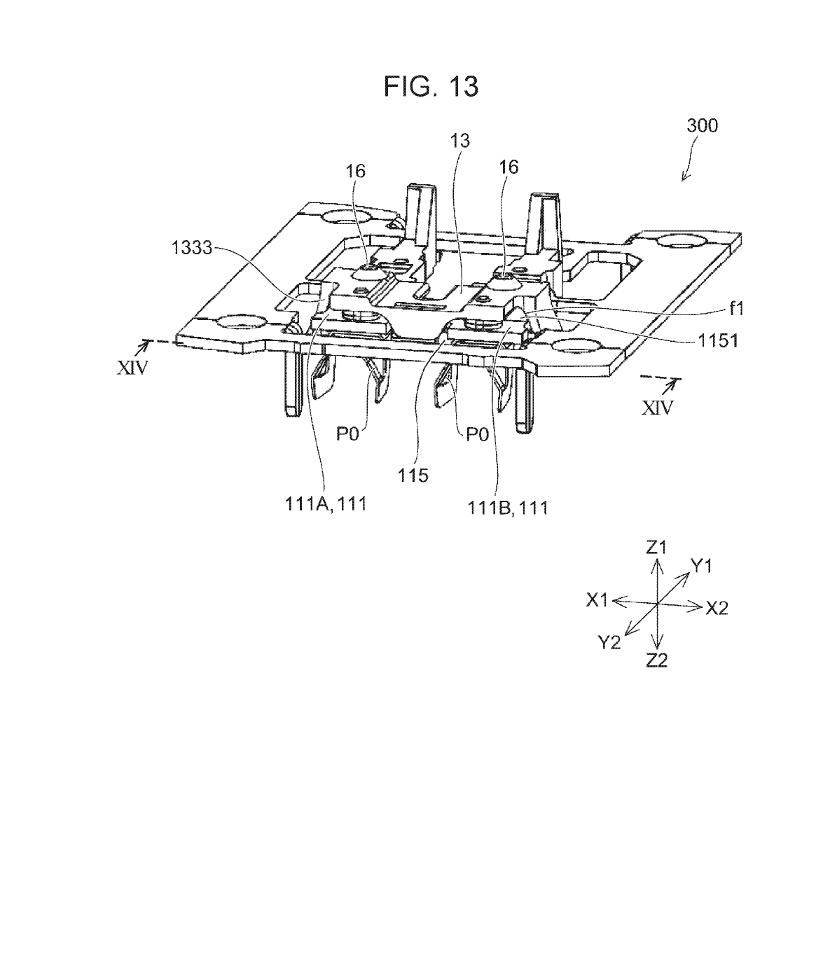

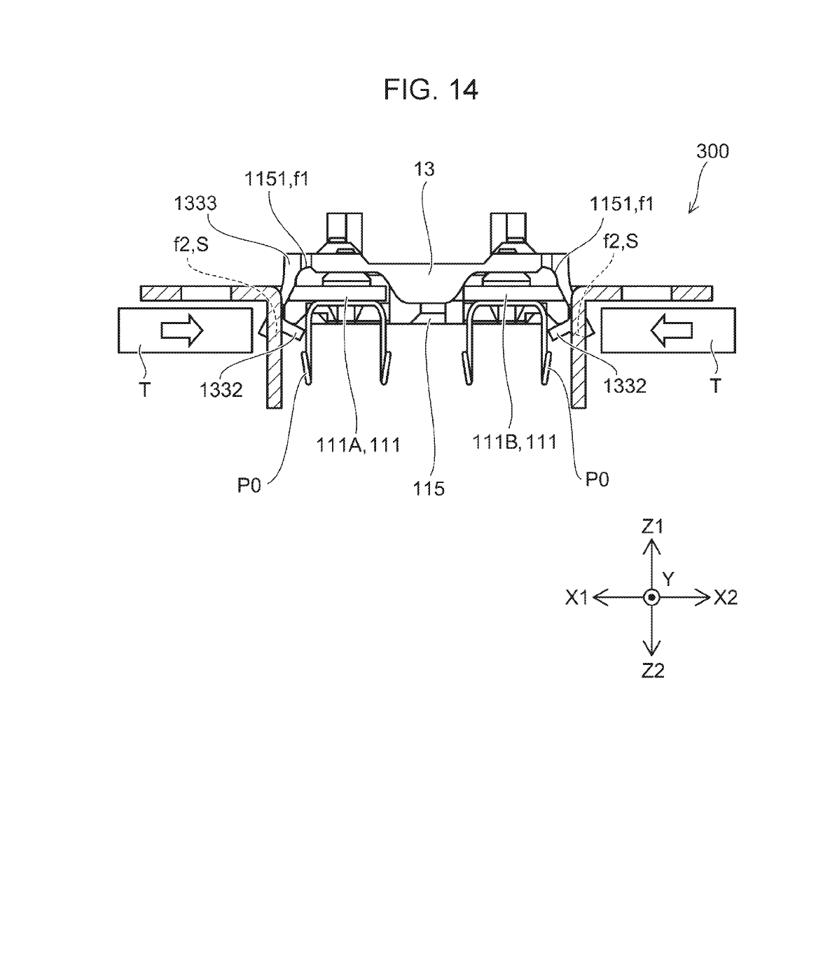

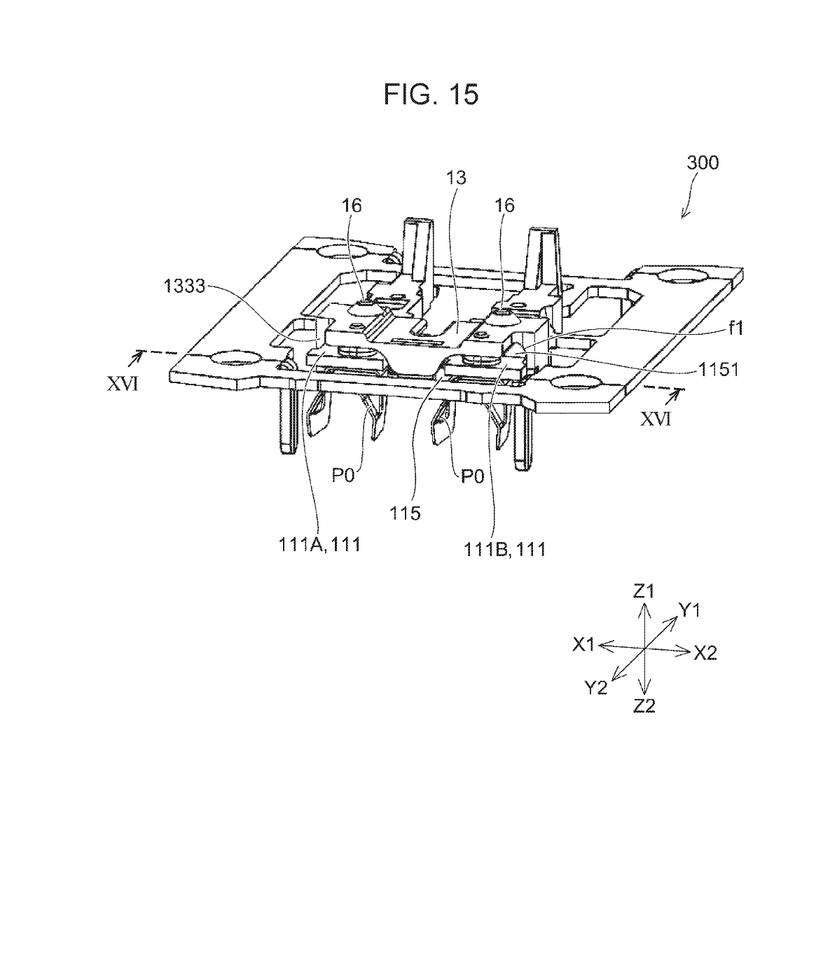

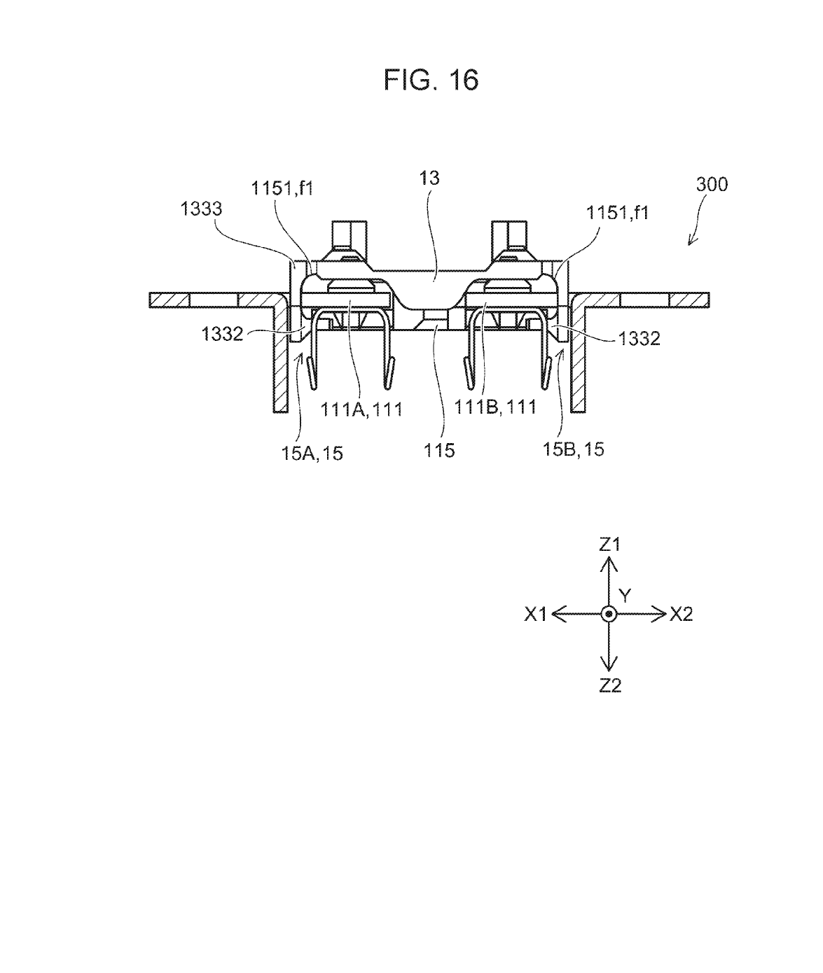

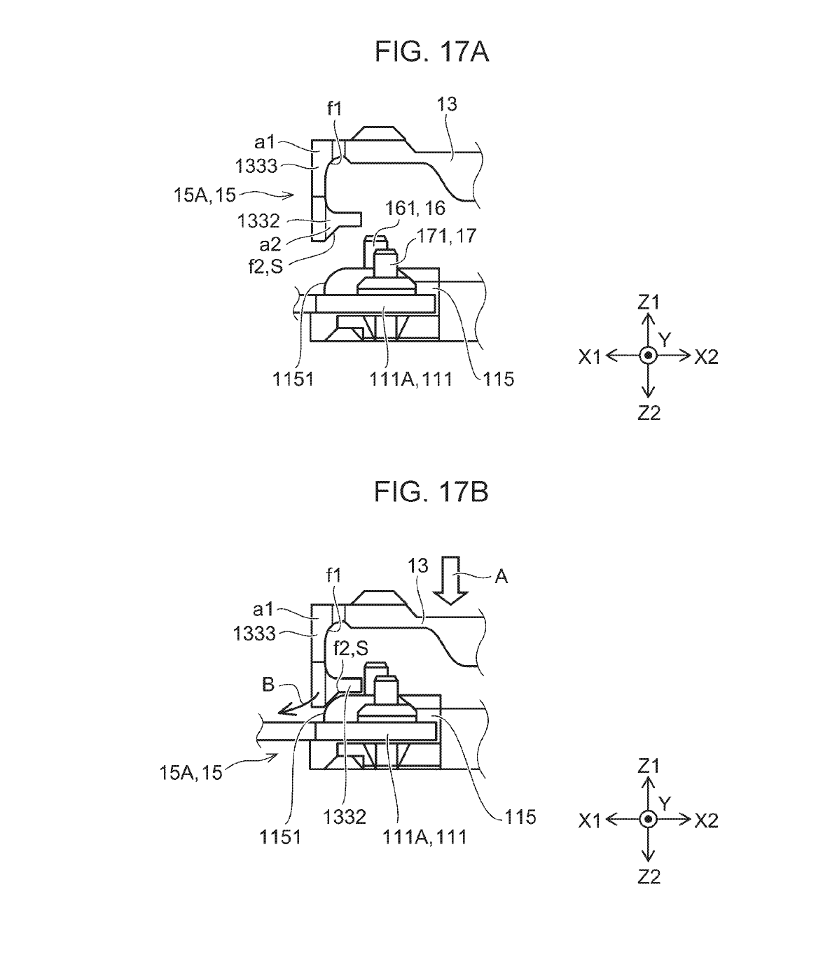

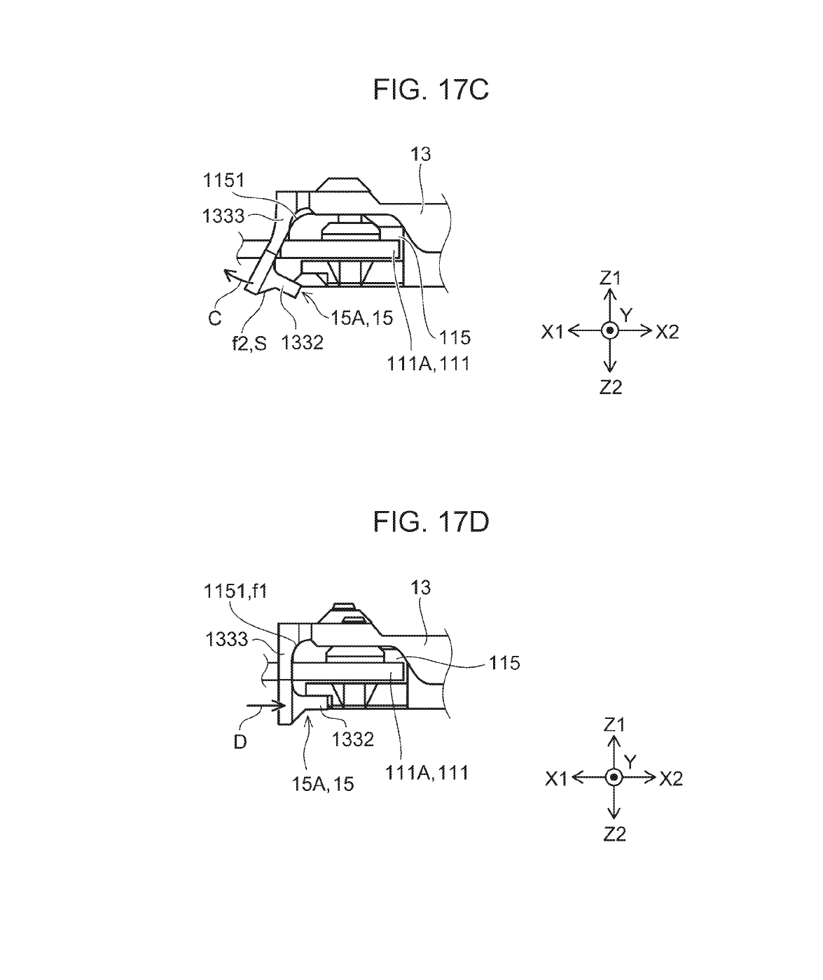

FIGS. 11 to 17D are diagrams illustrating an example method of attaching the elastic member. FIGS. 11, 13, and 15 are perspective views of the hoop material 300 as viewed obliquely from above. FIG. 12 is a cross-sectional view taken along line XII–XII of FIG. 11, FIG. 14 is a cross-sectional view taken along line XIV–XIV of FIG. 13, and FIG. 16 is a cross-sectional view taken along line XVI–XVI of FIG. 15. FIGS. 17A to 17D are partially enlarged views illustrating engagement states between the elastic member 13 and the drive coupling section 115, on the first engagement structure 15A side.

First, as illustrated in FIGS. 11, 12, and 17A, the elastic member 13 is placed above the drive coupling section 115 of the hoop material 300. A positioning member 16 for positioning the elastic member 13 with respect to the drive coupling section 115 is disposed between the drive coupling section 115 and the elastic member 13. For example, the positioning member 16 includes a protrusion 161 provided on the drive coupling section 115 side and a hole 162 provided on the elastic member 13 side. By fitting the protrusion 161, which serves as a positioning protrusion, into the hole 162, which serves as an engagement hole, the elastic member 13 is positioned with respect to the drive coupling section 115. Alternatively, the positioning member 16 may include a hole that is provided on the drive coupling section 115 side and a protrusion that is provided on the elastic member 13 side. Furthermore, the positioning member 16 may be a protrusion–recess abutment structure, and does not necessarily need to have a relationship in which one retains the other.

In addition, a fastening auxiliary portion 17 for preventing disengagement of the engagement structure 15 is provided between the drive coupling section 115 and the elastic member 13. The fastening auxiliary portion 17 includes a protrusion 171 provided on the drive coupling section 115 side and a hole 172 provided on the elastic member 13 side. By fitting the protrusion 171 into the hole 172, lifting or curling of the elastic member 13 from the drive coupling section 115 is prevented, and the elastic member 13 is retained to the drive member 11 so as not to fall off. Alternatively, the fastening auxiliary portion 17 may include a hole that is provided on the drive coupling section 115 side and a protrusion that is provided on the elastic member 13 side. In one example, a disengagement direction is opposite to an engagement direction in the same direction; however, when disengagement is prevented by restricting displacement of the elastic member 13 in a state before the member is deformed in the engagement direction during engagement, a direction for preventing disengagement does not need to coincide with the disengagement direction. The above-described fastening auxiliary portion 17 restricts displacement of the elastic member 13 in the Z1–Z2 direction. This direction is different from the engagement direction of the elastic member 13 (the X1–X2 direction, the Y1–Y2 direction). However, even if the elastic member 13 is displaced in a disengagement direction (for example, the X1–X2 direction), as long as the elastic member 13 is not displaced in the Z1–Z2 direction, re-engagement is possible, and as a result, disengagement can be prevented.

Here, the protrusion 171 of the fastening auxiliary portion 17 protrudes in the same direction as the protrusion 161 of the positioning member 16. It is preferable that the protrusion 161 of the positioning member 16 protrudes farther than the protrusion 171 of the fastening auxiliary portion 17. With this configuration, the protrusion 161 of the positioning member 16 engages with the elastic member 13 earlier than the protrusion 171 of the fastening auxiliary portion 17, and thus engagement of the fastening auxiliary portion 17 is started in the positioned state, and accordingly, improper engagement is less likely to occur. When engagement of the positioning member 16 is performed before engagement of the fastening auxiliary portion 17, occurrence of improper engagement between the protrusion 161 of the positioning member 16 and the hole 162 is more stably suppressed.

Next, as illustrated in FIG. 13, FIG. 14, FIG. 17B, and FIG. 17C, in a state in which the elastic member 13 is positioned with respect to the drive coupling section 115 by the positioning member 16, the elastic member 13 is fitted over the drive coupling section 115 from above (see arrow A in FIG. 17B).

The drive coupling section 115 includes a tapered portion 1151 that widens from one side (for example, the Z1 side) toward the other side (for example, the Z2 side) in a predetermined opposing direction (for example, the Z1–Z2 direction). The base portion 1333 has, in a first surface f1 that has a shape following the tapered portion 1151, on the one side in the opposing direction, a first portion a1 (see FIG. 12) configured to face the tapered portion 1151. The second support portion 1332 has, on the other side in the opposing direction, a second portion a2 (see FIG. 12) configured to face the tapered portion 1151. The second portion a2 has, on the other side in the opposing direction, a second surface f2 that has a shape following the tapered portion 1151.

The tapered portion 1151 serves as a guide portion that, during assembly of the drive coupling section 115 of the drive member 11 and the elastic member 13, when the drive coupling section 115 and the elastic member 13 are moved toward each other in the first direction (Z1–Z2 direction), comes into contact with the second support portion 1332 and elastically deforms the base portion 1333, thereby moving the second support portion 1332 to a position at which the second support portion 1332 can engage with the drive coupling section 115.

The second support portion 1332 has, in at least part of the second surface f2 that comes into contact with the tapered portion 1151 during assembly of the drive coupling section 115 and the elastic member 13, an inclined portion S. The inclined portion S elastically deforms the base portion 1333 so as to follow the tapered portion 1151 when the elastic member 13 is assembled to the drive coupling section 115. For example, when the elastic member 13 is fitted over the drive coupling section 115 from above, the inclined portion S of the second support portion 1332 of the elastic member 13 comes into contact with the tapered portion 1151 of the drive coupling section 115 and guides the second support portion 1332 so as to be pushed outward (see arrow B in FIG. 17B). As a result, the elastic member 13 is fitted onto the drive coupling section 115 in a state in which the second support portion 1332 is spread outward (see arrow C in FIG. 17C).

Next, as illustrated in FIG. 14, a tool T is pressed against the second support portion 1332 from an outer side to push the second support portion 1332 inward, and locking is performed by the engagement structure 15 (see arrow D in FIG. 17D). As a result, as illustrated in FIGS. 15 and 16, the elastic member 13 is securely fixed by the engagement structure 15 in a state in which the elastic member 13 is fitted over the drive coupling section 115 from above. In this manner, the elastic member 13 is elastically deformed and thereby retained to the drive member 11 so as not to fall off.

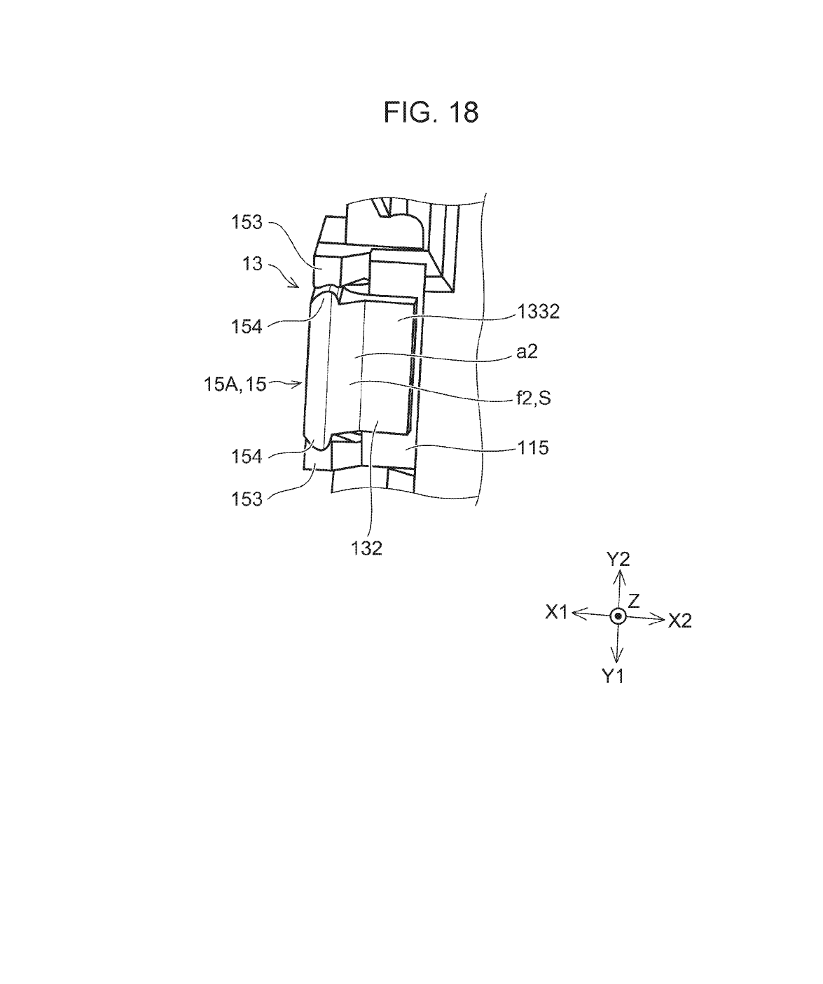

FIG. 18 is a perspective view illustrating the engagement structure provided for the second support section. FIG. 18 is a perspective view of the engagement structure 15 illustrated in FIG. 17D, as viewed from the Z2 side in the Z1–Z2 direction. The engagement structure 15 for engaging the second support portion 1332 with the drive coupling section 115 has a structure for locking the second support portion 1332, which has been moved over the tapered portion 1151 during assembly of the drive coupling section 115 and the elastic member 13, to the drive coupling section 115. Specifically, the locking structure is configured to lock the second portion a2 to the drive coupling section 115, with an engagement direction being a direction intersecting the opposing direction and the first direction (for example, the X1–X2 direction).

For example, the second portion a2 of the second support portion 1332 is bent in a substantially L shape with respect to the base portion 1333, and the second surface f2 has an inclined portion S and the second abutment portion 132. When the elastic member 13 is fitted onto the drive coupling section 115 and the second support portion 1332 is spread outward, the second support portion 1332 is pushed inward with the tool T, so that the second portion a2, which is bent into a substantially L-shape, comes into contact with a lower surface side of the drive coupling section 115. The engagement structure 15 achieves so-called snap-fit engagement by fitting a convex portion 154 provided in the second portion a2 into a concave portion 153 provided in the drive coupling section 115. By this engagement, the elastic member 13 is locked in the first direction (Z1–Z2 direction) and in a direction intersecting the first direction (for example, the Y1–Y2 direction).

As illustrated in FIG. 7, when the first holding portion 111A and the second holding portion 111B are provided, two engagement structures 15, that is, the first engagement structure 15A and the second engagement structure 15B, are provided between the elastic member 13 and the drive coupling section 115. In the first engagement structure 15A and the second engagement structure 15B, disengagement directions are different from each other. The disengagement direction refers to a direction different from a direction in which locking is loosened (for example, the Z1–Z2 direction). This prevents all of the first engagement structure 15A and the second engagement structure 15B from disengaging due to an external force applied in a direction different from the first direction, thereby preventing the elastic member 13 from falling off the drive coupling section 115.

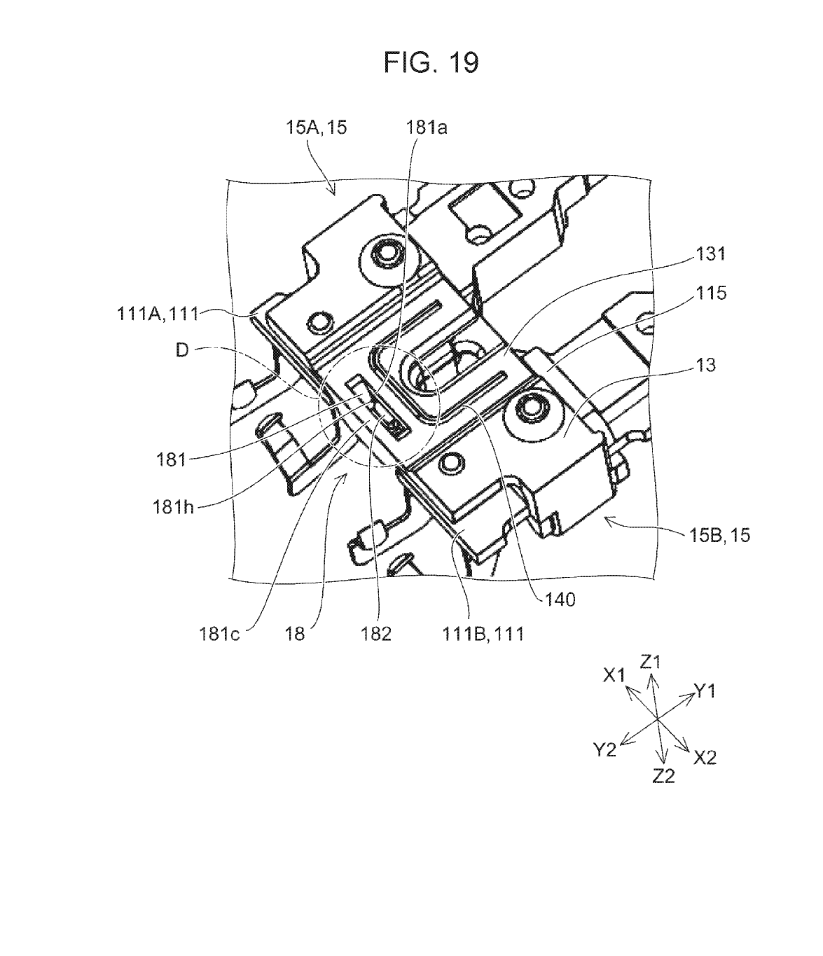

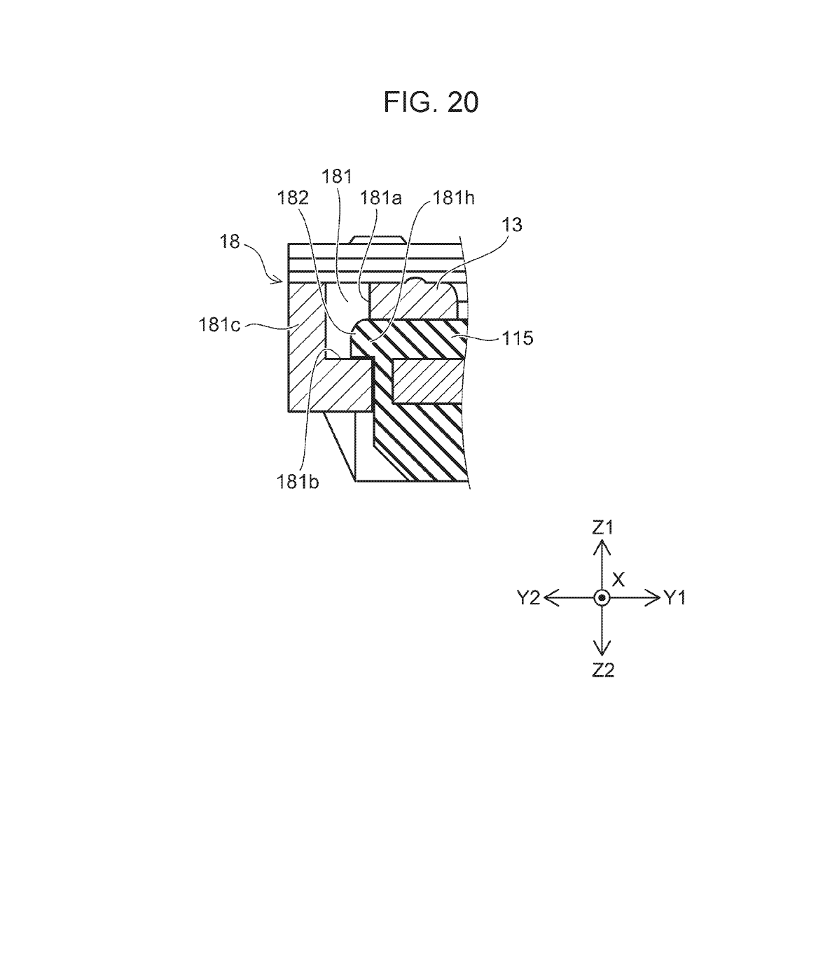

FIG. 19 is a perspective view illustrating another engagement structure. FIG. 20 is an enlarged cross-sectional view illustrating another engagement structure. FIG. 20 is an enlarged cross-sectional view of a portion D in FIG. 19. Another engagement structure 18 is provided between the drive coupling section 115 and the elastic member 13 at a position different from that of the engagement structure 15. Specifically, the engagement structure 18 is provided between the first engagement structure 15A and the second engagement structure 15B in the X1–X2 direction, and is provided on the Y2 side relative to the first engagement structure 15A and the second engagement structure 15B in the Y1–Y2 direction. The engagement structure 18 includes a concave portion 181 provided in the elastic member 13 and an engagement protrusion 182 provided in the drive coupling section 115 of the drive member 11. The concave portion 181 opens in the Z1–Z2 direction (first direction) and has a through portion 181h in one (side wall portion 181a) of side wall portions.

The engagement protrusion 182 passes through the through portion 181h provided in the elastic member 13 and locks a bottom portion 181b of the concave portion 181. In the concave portion 181 of the engagement structure 18, a side wall portion 181c that faces the through portion 181h and is continuous with the bottom portion 181b has a predetermined thickness in a disengagement direction of the engagement structure 18.

With such an engagement structure 18, lifting or curling of the elastic member 13 is prevented. For example, when the holding portion 111 swings, a distal end side (Y2 side) moves by a greater amount than a fulcrum side (Y1 side). If the elastic member 13 adheres to the stopper 12 (see FIGS. 4 and 5), swinging of the holding portion 111 tends to cause the elastic member 13 to detach from the drive coupling section 115 or to curl on the Y2 side. The engagement structure 18 being disposed on the Y2 side of the elastic member 13 effectively prevents the elastic member 13 from lifting or curling.

In addition, even when the concave portion 181 is provided in the elastic member 13, reinforcement is achieved by the side wall portion 181c having a predetermined thickness, thereby effectively suppressing elastic deformation at the concave portion 181.

According to the embodiment, the switch device 1 in which the elastic member 13 for suppressing impact noise produced between the drive member 11 and the stopper 12 can be sufficiently supported to the drive member 11 can be provided.

Although the embodiments have been described above, the present invention is not limited to the embodiments. For example, contact between the movable contact P0 and the first contact P1 and the second contact P2 may be sliding contact or abutting contact. In addition, while the contact-type detecting section and section to be detected using the movable contact P0 and the first contact P1 and the second contact P2 have been described, other types of detecting portions and portions to be detected may be used, such as an optical type (a light-emitting/receiving unit and a shielding plate) or a magnetic type (a magnetic sensor and a magnetic field generating means). In such a case, the detecting section may be provided in the drive member 11, or the section to be detected may be provided in the drive member 11. It is to be understood that any component may be added, any of the above-described components may be omitted, or any of the above-described designs may be modified, or any features of the configurations according to the embodiments may be combined appropriately by a person skilled in the art without departing from the scope of the invention, and such modifications are included within the scope of the invention.

What is claimed is:

1. A switch device comprising:
a drive member including a detection section or a section to be detected, the drive member being configured to change a relative position between the detection section and the section to be detected by a reciprocating operation in a first direction;
a stopper disposed at a position having a fixed relative positional relationship with respect to the other of the detection section and the section to be detected, the stopper being configured to come into contact with the drive member to restrict a range of movement of the drive member; and
an elastic member retained to the drive member, wherein
the stopper includes a first stopper configured to restrict movement on one side in the first direction, and a second stopper configured to restrict movement on the other side in the first direction, and
the elastic member includes
a first abutment portion configured to come into contact with the first stopper,
a second abutment portion configured to come into contact with the second stopper, and
a connecting portion that connects the first abutment portion and the second abutment portion.

2. The switch device according to claim 1, wherein the elastic member is a separate member comprising a material softer than that of the drive member, and has an engagement structure configured to lock the elastic member to the drive member.

3. The switch device according to claim 2, wherein the elastic member is elastically deformed to be retained to the drive member so as not to fall off.

4. The switch device according to claim 1, wherein
the connecting portion includes
a first support portion having a portion of the first abutment portion located on the other side in the first direction and supports the first abutment portion,
a second support portion having a portion of the second abutment portion located on the one side in the first direction and supports the second abutment portion, and
a base portion located between the first support portion and the second support portion, and
the first support portion and the second support portion extend in a direction intersecting the first direction, from different positions in the base portion in the first direction.

5. The switch device according to claim 1, further comprising a positioning member configured to position the elastic member with respect to the drive member.

6. The switch device according to claim 2, wherein the engagement structure comprises a plurality of engagement structures.

7. The switch device according to claim 6, wherein a disengagement direction of at least one of the plurality of engagement structures differs from that of other engagement structures.

8. The switch device according to claim 2, further comprising a fastening auxiliary portion configured to prevent disengagement of the engagement structure.

9. The switch device according to claim 8, wherein the fastening auxiliary portion includes a protrusion and a hole into which the protrusion is inserted.

10. The switch device according to claim 9, further comprising a positioning member configured to position the elastic member with respect to the drive member, wherein
the positioning member includes a positioning protrusion provided in the drive member, and an engagement hole provided in the elastic member and into which the positioning protrusion is inserted,
the protrusion of the fastening auxiliary portion is provided to the drive member and protrudes in the same direction as the positioning protrusion, and
the positioning protrusion protrudes farther than the protrusion of the fastening auxiliary portion.

11. The switch device according to claim 2, wherein
the engagement structure includes
a concave portion provided in the elastic member, the concave portion opening in the first direction and having a through portion in one of side wall portions thereof, and
an engagement protrusion provided in the drive member and configured to pass through the through portion and lock a bottom portion of the concave portion, and
in the concave portion, a side wall portion that faces the through portion and is continuous with the bottom portion has a predetermined thickness in a disengagement direction of the engagement structure.

12. The switch device according to claim 6, wherein
the drive member includes a first holding portion and a second holding portion disposed side by side in a second direction intersecting the first direction, and a drive coupling section that
couples the first holding portion and the second holding portion, and
the elastic member is provided so as to extend across the first holding portion and the second holding portion, and has a first engagement structure that is locked to the first holding portion and a second engagement structure that is locked to the second holding portion.

13. The switch device according to claim 12, wherein, when viewed in the first direction, the first abutment portion has a portion overlapping the drive coupling section.

14. The switch device according to claim 12, wherein
the second abutment portion comprises two second abutment portions, and
when viewed in the first direction,
one of the two second abutment portions has a portion overlapping the first holding portion, and
the other of the two second abutment portions has a portion overlapping the second holding portion.

15. The switch device according to claim 4, wherein the drive member has a guide portion that, during assembly of the drive member and the elastic member, comes into contact with the second support portion to elastically deform the base portion and move the second support portion to a position at which the second support portion is engageable with the drive member.

16. The switch device according to claim 15, wherein the second support portion has, in a portion that comes into contact with the guide portion during assembly of the drive member and the elastic member, an inclined portion having a shape following the guide portion.

17. The switch device according to claim 15, further comprising an engagement structure that locks the second support portion that has moved over the guide portion during assembly of the drive member and the elastic member to the drive member.

18. The switch device according to claim 4, wherein
the drive member has a tapered portion that widens from one side toward the other side in a predetermined opposing direction,
the base portion has, in a first surface having a shape following the tapered portion, on the one side in the opposing direction, a first portion that faces the tapered portion,
the second support portion has, on the other side in the opposing direction, a second portion that faces the tapered portion, and
the second portion has, on the other side in the opposing direction, a second surface that has a shape following the tapered portion.

19. The switch device according to claim 18, further comprising an engagement structure that locks the second portion to the drive member, with an engagement direction being a direction intersecting the opposing direction and the first direction.

20. The switch device according to claim 2, wherein
the drive member and the engagement structure are locked such that opposing surfaces thereof overlap with each other when viewed from the first direction,
a side of the drive member opposite to the opposing surface has a tapered portion, and
a side of the engagement structure opposite to the opposing surface has a surface having a shape following the tapered portion.

21. The switch device according to claim 1, wherein at least one of the first abutment portion and the first stopper has an adhesion-preventing portion, or

22. The switch device according to claim 1, wherein at least one of the second abutment portion and the second stopper has an adhesion-preventing portion.

23. The switch device according to claim 1, further comprising a quick-action mechanism.
